(19) United States
(12) Patent Application Publication
(10) Pub. No.: US 2013/0088399 A1
(43) Pub. Date: Apr. 11, 2013

(54) ANTENNA HAVING A FEEDING STRUCTURE, AND A FEEDING METHOD

(71) Applicant: RADINA CO., LTD, Seoul (KR)

(72) Inventors: Sin-Hyung JEON, Seoul (KR); Hyeng-Cheul Choi, Seoul (KR); Jae-Seok Lee, Seoul (KR); Oul Cho, Suwon-si (KR); Seung-Woo Kim, Gunpo-si (KR); Gyu-Han Kim, Seoul (KR)

(73) Assignee: RADINA CO., LTD, Seoul (KR)

(21) Appl. No.: 13/645,534

(22) Filed: Oct. 5, 2012

(30) Foreign Application Priority Data
Apr. 6, 2010 (KR) 10-2010-0031240
Apr. 6, 2010 (KR) 10-2010-0031243
May 7, 2010 (KR) 10-2010-0042963
Apr. 6, 2011 (KR) 10-2011-0031507

(51) Int. Cl. H01Q 1/50

(52) U.S. Cl. CPC H01Q 1/50
USPC 343/749

(57) ABSTRACT

Provided is an antenna having broadband frequency characteristics due to the use of a power supply structural body having a closed loop consisting of a conductive circuit and an inductive element, such that the capacitance due to a capacitive element and the inductance due to the closed loop give rise to resonance, and the magnetic flux generated in the closed loop at the resonance frequency is coupled to a radiator. Also provided is an antenna having broadband characteristics in a plurality of bands.

### CROSS REFERENCE TO PRIOR APPLICATIONS

This application is a Continuation Application of a PCT International Patent Application No. PCT/KR2011/002421 (filed on Apr. 6, 2011), which claims priority to Korean Patent Application Nos. 10-2010-0031243 (filed on Apr. 6, 2010), 10-2010-0031240 (filed on Apr. 6, 2010), 10-2010-0042963 (filed on May 7, 2010), and 10-2011-0031507 (filed on Apr. 6, 2011), which are all hereby incorporated by reference in their entirety.

### BACKGROUND

1. Technical Field

The present invention relates to an antenna and an antenna feeding method, and more specifically, to an antenna having a feeding structure for broadband feeding and a method of feeding signals to the antenna using the feeding structure.

2. Background Art

An antenna is an apparatus for receiving RF signals in the air inside a terminal and transmitting signals inside the terminal to outside, and it is an indispensable element in communicating with outside in a wireless device.

FIG. 1 is a view showing a single band antenna according to a conventional technique. Referring to FIG. 1, the single band antenna 10 according to a conventional technique includes a ground 11 for providing a ground potential and functioning as a radiator, a feeding unit 12, a ground pin 13, and a radiator 14. In addition, the feeding unit 12 includes a feeding source 121 and a matching element 122 for impedance matching.

FIG. 2 is a view showing frequency characteristics of an antenna according to FIG. 1. The radiator 14 of the antenna according to FIG. 1 is designed to generate resonance at a low frequency. That is, as shown in FIG. 2, the radiator 14 may be designed to generate resonance at a frequency of 780 MHz with a bandwidth of 740 to 815 MHz.

FIG. 3 is a view showing a multi-band antenna according to a conventional technique. Referring to FIG. 3, the multi-band antenna 30 according to a conventional technique includes a ground 31, a feeding unit 32, a ground pin 33, a first radiator 34, and a second radiator 35. In addition, the feeding unit 32 is configured with a feeding source 321 or includes the feeding source 321 and a matching element 322 for impedance matching.

FIG. 4 is a view showing characteristics of an antenna in a high frequency domain according to FIG. 3. If the first radiator 34 of the antenna according to FIG. 3 is designed to generate resonance at a low frequency, the resonance is generated in a low frequency domain of 780 MHz as shown in FIG. 2, with a bandwidth of 740 to 815 MHz. On the other hand, the second radiator 35 of the antenna according to FIG. 3 may be designed to generate resonance in a high frequency domain. Accordingly, as shown in FIG. 4, the second radiator 35 may be designed to generate resonance at a frequency of 1.8 GHz.

As shown in FIGS. 2 and 4, the antenna according to a conventional technique does not have a broadband characteristic. In addition, as shown in FIG. 4, although the antenna according to a conventional technique generates resonance in a high frequency domain, antenna characteristics thereof are not excellent.

According to the conventional technique, a lot of efforts has been made to enhance performance of an antenna by improving resonance characteristics of an antenna radiator. However, there is a limit in improving the performance of an antenna only by changing the configuration of the antenna radiator.

Accordingly, required is a method of efficiently improving performance of an antenna in a further simple way.

### SUMMARY OF THE INVENTION

Therefore, the present invention has been made in view of the above problems, and it is an object of the present invention to provide a feeding structure and an antenna using thereof, in which the antenna may operate as a broadband antenna while having a simple shape.

Another object of the present invention is to provide a feeding structure and an antenna using thereof, in which the antenna may operate as a multi-band antenna while having a simple shape.

Another object of the present invention is to provide a broadband feeding method using a feeding structure.

In the present invention, resonance is generated by a feeding structure at a frequency adjacent to a resonance frequency of a radiator. An antenna radiator is excited due to the magnetic flux generated by the feeding structure, and thus an antenna may have broadband characteristics.

In addition, resonance is generated by the feeding structure at two or more frequencies, and thus the antenna may have multi-band characteristics.

An antenna having a feeding structure according to the present invention has broadband characteristics while having a simple structure.

The feeding structure according to the present invention has multi-band characteristics while having a simple structure.

### BRIEF DESCRIPTION OF THE DRAWINGS

FIG. 1 is a view showing a single band antenna according to a conventional technique.

FIG. 2 is a view showing frequency characteristics of an antenna according to FIG. 1.

FIG. 3 is a view showing a multi-band antenna according to a conventional technique.

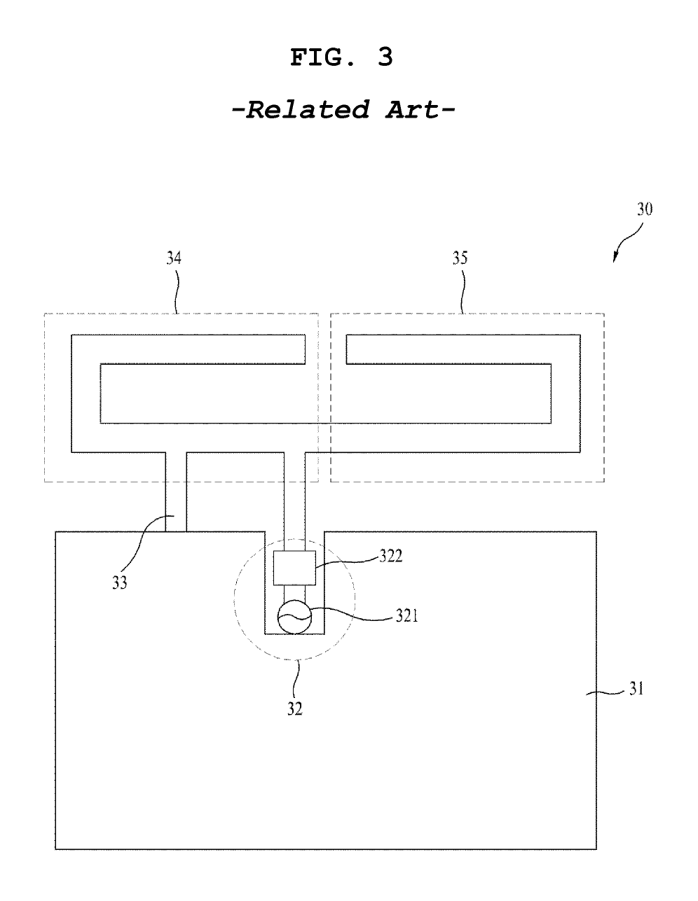

FIG. 4 is a view showing characteristics of an antenna in a high frequency domain according to FIG. 3.

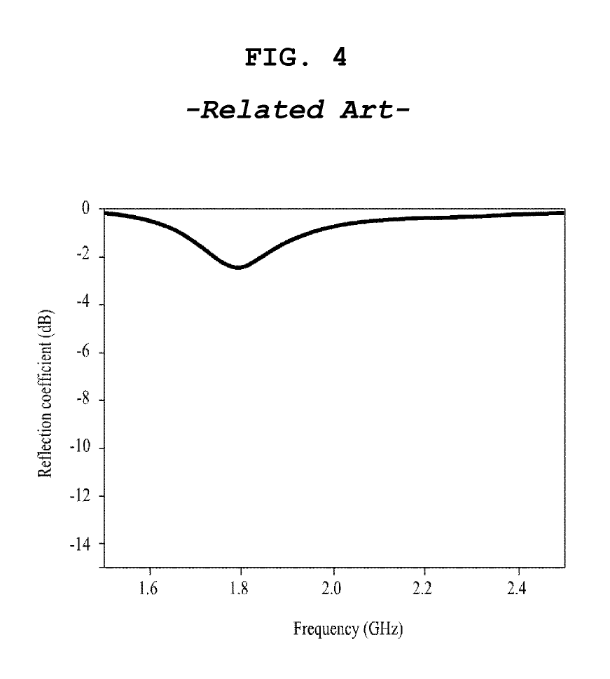

FIG. 5 is a view showing a feeding structure for an antenna according to a first embodiment of the present invention.

FIG. 6 is a view showing various embodiments of a feeding structure of an antenna according to the present invention.

FIG. 7 is a view showing an antenna applying the feeding structure shown in FIG. 5 according to a first embodiment of the present invention.

FIG. 8 is a view showing frequency characteristics of an antenna according to the embodiment of FIG. 7.

FIG. 9 is a view showing a feeding structure for an antenna according to a second embodiment of the present invention.

FIGS. 10A and 10B are views showing operating principles of the feeding structure shown in FIG. 9.

FIG. 11 is a view showing an antenna applying the feeding structure shown in FIG. 9 according to a second embodiment of the present invention.

FIG. 12 is a view showing frequency characteristics of an antenna according to the embodiment of FIG. 11.

### DETAILED DISCLOSURE OF THE INVENTION

The present invention includes a feeding structure and a radiator having a first resonant frequency and radiating a signal provided by the feeding structure to outside. The feeding structure includes a feeding unit for providing the signal and a closed loop formed by a capacitive element and a conducting line, and a second resonance frequency generated by the closed loop is preferably a frequency adjacent to the first resonance frequency.

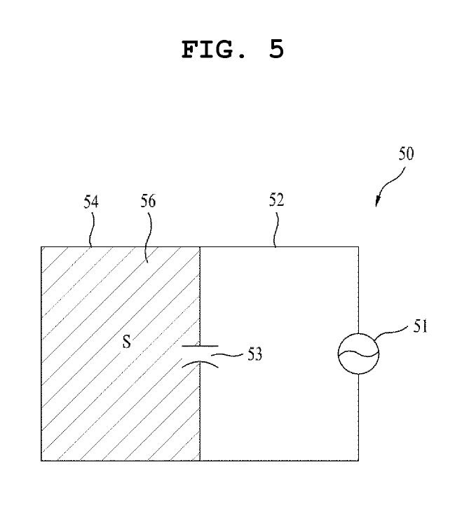

FIG. 5 is a view showing a feeding structure for an antenna according to a first embodiment of the present invention. As shown in FIG. 5, the feeding structure for an antenna according to the present invention includes a feeding unit 51, a capacitive element 53, a first conducting line 52 connecting both ends of the feeding unit and both ends of the capacitive element 53, and a second conducting line 54 connecting both ends of the capacitive element 53 and both ends of the feeding unit 51.

The feeding unit 51 may be configured only with a feeding source for providing an RF signal or includes the feeding source and a matching element for impedance matching.

Meanwhile, the second conducting line 54 connecting both ends of the capacitive element 53 forms a closed loop having a certain area S, together with the capacitive element 53.

Operating principles of the feeding unit shown in FIG. 5 are described below. In an RF environment, a closed loop 56 is formed by the capacitive element 53 and the second conducting line 54, and inductance is generated in the closed loop 56 by the conducting line and the loop. The inductance and capacitance of the capacitive element 53 generate resonance at a specific frequency. At the resonance frequency, current flowing through the closed loop 56 generates magnetic flux through the closed loop, and the magnetic flux generated in the closed loop is provided to the antenna radiator.

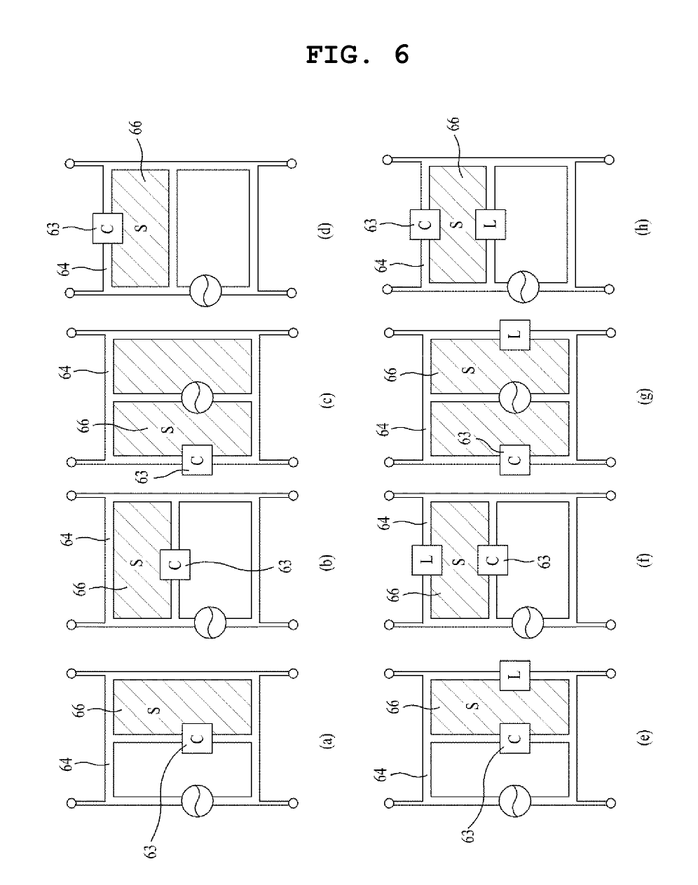

FIG. 6 is a view showing various embodiments of a feeding structure of an antenna according to the present invention. Although various forms of antenna feeding structures are shown in FIG. 6, they commonly have the features described in FIG. 5. That is, a closed loop 66 is formed by a conducting line 64 and a capacitive element 63, and inductance of the closed loop 66 and capacitance of the capacitive element 63 generate resonance. In addition, magnetic flux generated in the closed loop 66 may be provided to the antenna radiator.

Meanwhile, in (e), (f), (g) and (h) among the embodiments shown in FIG. 6, the closed loop 66 is formed by an inductive element 65, as well as the capacitive element 63 and the conducting line 64. Here, the inductive element 65 reinforces the inductance generated in the closed loop 66. That is, if the inductance generated in the closed loop 66 is insufficient for generating resonance at a desired frequency, inductance generated by a lumped circuit element is added to reinforce the inductance.

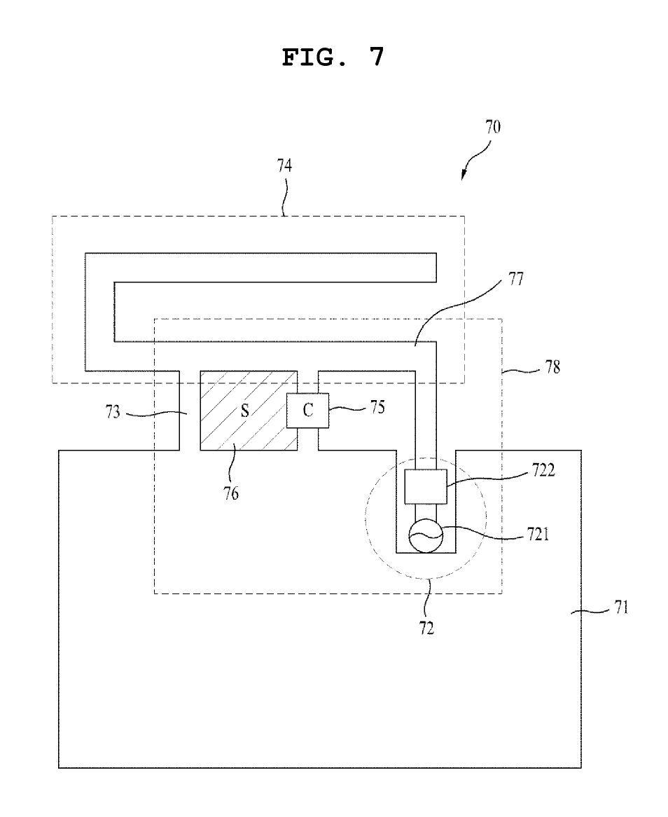

FIG. 7 is a view showing an antenna applying the feeding structure shown in FIG. 5 according to a first embodiment of the present invention.

Referring to FIG. 7, the antenna according to the present invention includes a ground 71, a radiator 74 and a feeding structure 78.

A feeding unit 72 may be configured only with a feeding source 721 or by adding a matching element 722 for impedance matching to the feeding source 721.

The feeding structure 78 shown in FIG. 5 is formed by the feeding unit 72, a first conducting line 77, a capacitive element 75 and a second conducting line 73. Although the feeding structure 78 shown in FIG. 5 is applied to the antenna of the embodiment, any one of the feeding structures shown in FIG. 6 can be selected and applied.

As is specified in the description of the feeding structure according to FIG. 5, a resonance phenomenon occurs at a specific frequency due to inductance of a closed loop 76 and capacitance of the capacitive element 75. At this point, the closed loop 76 is formed by the capacitive element 75 and the second conducting line 73. Current generated by the resonance generates magnetic flux in the closed loop 76, and if the magnetic flux generated by the closed loop 76 excites the radiator 74, a signal is radiated to outside through the radiator 74 at the resonance frequency of the closed loop 76.

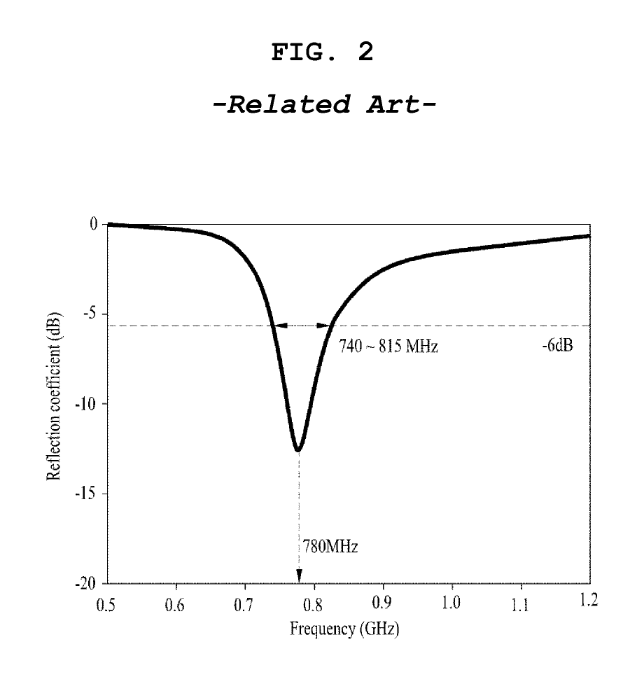

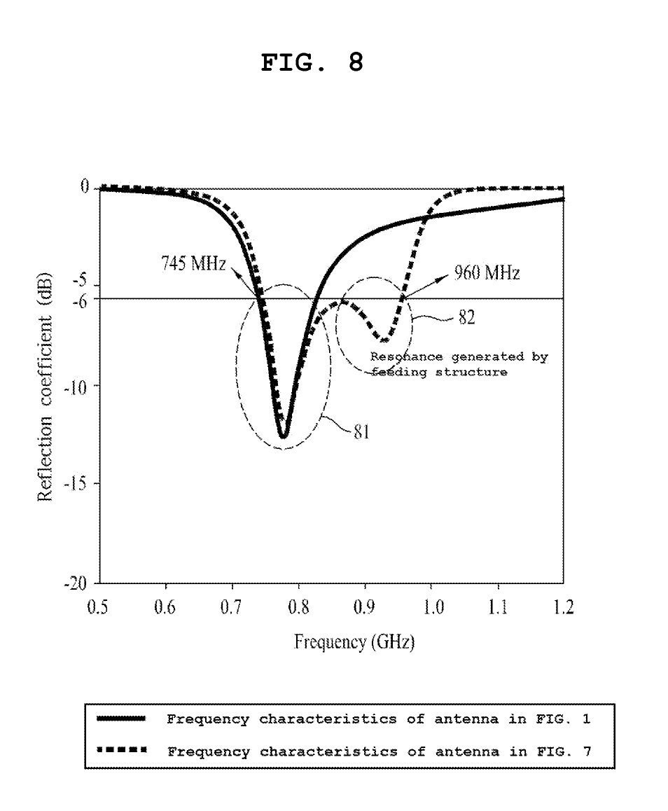

FIG. 8 is a view showing frequency characteristics of an antenna according to the embodiment of FIG. 7. Comparing the graph shown in FIG. 8 and the graph shown in FIG. 2, it is under stood that the band of the graph shown in FIG. 8 is much wider than the band of the graph shown in FIG. 2.

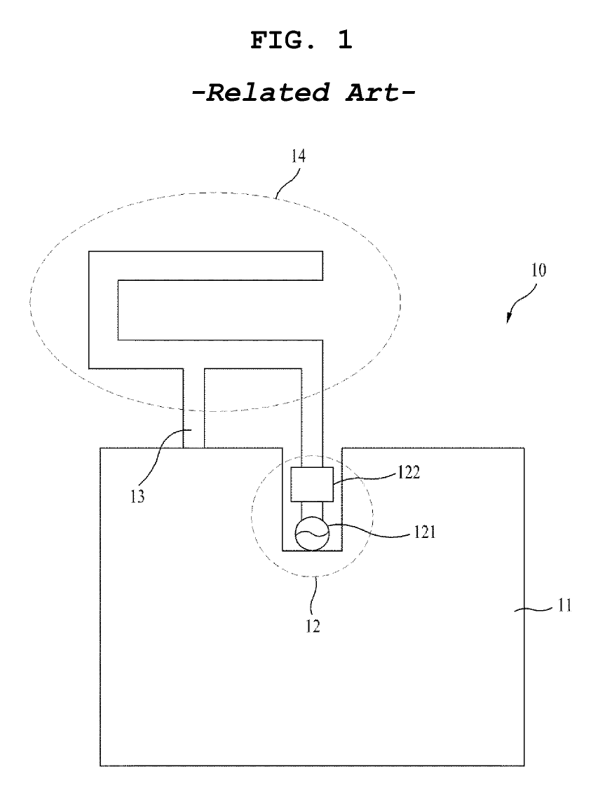

That is, if the feeding structure shown in FIG. 5 is applied to an antenna according to the conventional technique, a resonance band 82 formed by the feeding structure is added to the resonance band 81 formed by the antenna radiator according to FIG. 1, and thus the band is extended.

Accordingly, a resonance band is formed by the feeding structure around the resonance frequency of a conventional radiator by adjusting a capacitance value and an inductance value, which are elements for generating resonance, and thus a broadband antenna can be designed. At this point, the capacitance needed for adjusting the resonance band can be obtained by changing the capacitance value of a lumped circuit element. In addition, the inductance value needed for adjusting the resonance band can be obtained by adjusting the area of the closed loop or by inserting an inductor, which is a lumped circuit element.

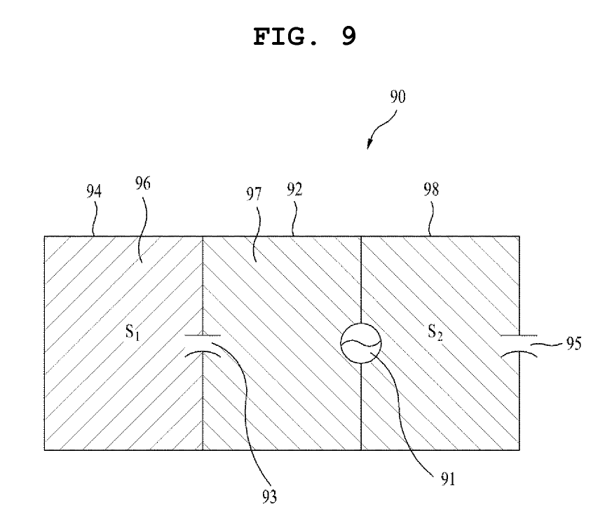

FIG. 9 is a view showing a feeding structure for an antenna according to a second embodiment of the present invention. As shown in FIG. 9, the feeding structure for an antenna according to a second embodiment of the present invention includes a feeding unit 91, a first capacitive element 93, a second capacitive element 95, a first conducting line 92, a second conducting line 94 and a third conducting line 98.

The feeding unit 91 may be configured only with a feeding source for providing an RF signal or includes the feeding source and a matching element for impedance matching.

The first conducting line 92 connects both ends of the feeding unit 91 and both ends of the first capacitive element 93. Meanwhile, the second conducting line 94 connecting both ends of the first capacitive element 93 forms a first closed loop 96 having a certain area S₁, together with the first capacitive element 93.

On the other hand, a second closed loop 97 having a certain area S₂ is formed by the first capacitive element 93, the second capacitive element 95, and the first conducting line 92 and the third conducting line 98 connecting the first and second capacitive elements.

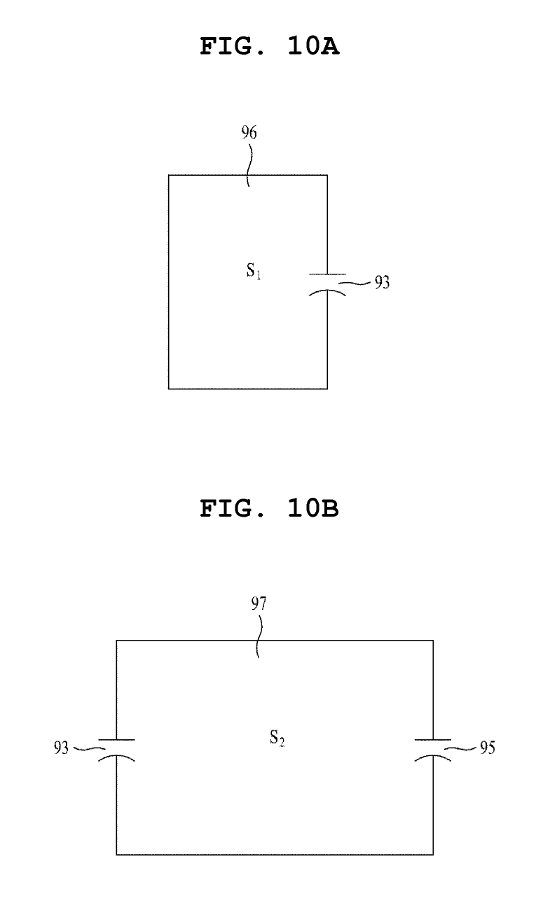

FIGS. 10A and 10B are views showing operating principles of the feeding structure shown in FIG. 9. If it is assumed that capacitance of the first capacitive element 93 is sufficiently larger than that of the second capacitive element 95, the feeding structure shown in FIG. 9 has two important resonance bands.

FIG. 10A is a view showing a first resonance circuit for generating resonance in a low frequency domain. Since current almost does not flow toward the second capacitive element 95 in the low frequency domain, resonance is generated in the first closed loop 96. That is, a first resonance band is formed by the inductance provided by the first closed loop 96 and the capacitance provided by the first capacitive element 93.

FIG. 10B is a view showing a second resonance circuit for generating resonance in a high frequency domain. Since inductance of a conducting line is high in the high frequency domain and thus current almost does not flow toward the first closed loop 96, resonance is generated by the second closed loop 97. That is, resonance is generated by the inductance provided by the second closed loop 97 and the capacitance provided by the first capacitive element 93 and the second capacitive element 95 (mainly the capacitance provided by the second capacitive element).

The first closed loop 96 and the second closed loop 97 provide magnetic flux generated in the resonance frequency bands to the antenna radiator. Accordingly, the antenna radiator radiates an RF signal to outside in the resonance frequency band of each closed loop.

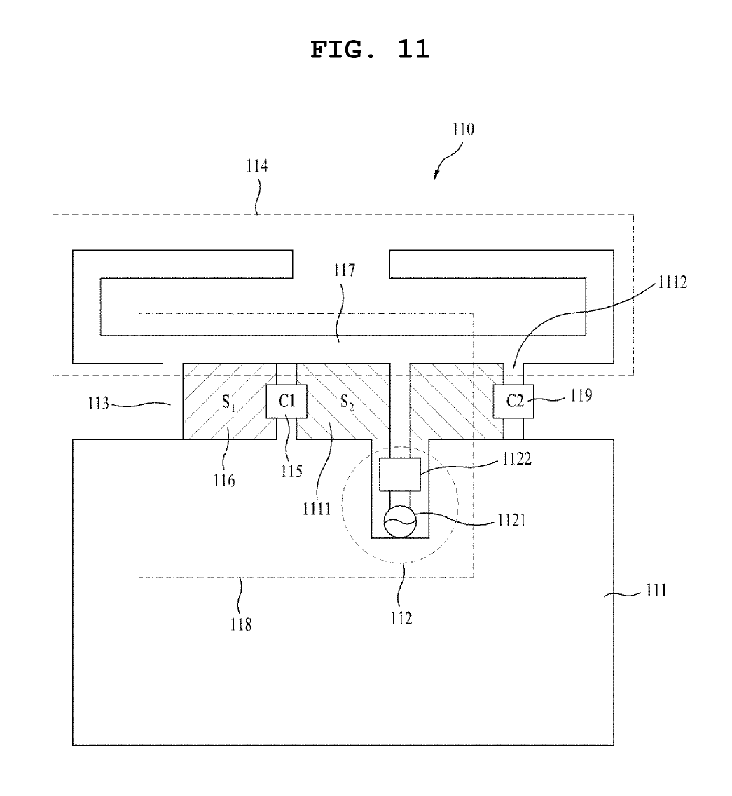

FIG. 11 is a view showing an antenna applying the feeding structure shown in FIG. 9 according to a second embodiment of the present invention.

Referring to FIG. 11, the antenna 110 according to the present invention includes a ground 111, a feeding unit 112, a radiator 114 and a feeding structure 118.

The feeding unit 112 may be configured only with a feeding source 1121 or by adding a matching element 1122 for impedance matching to the feeding source 1121.

The feeding structure shown in FIG. 9 is formed by the feeding unit 112, a first conducting line 117, a first capacitive element 115, a second conducting line 113, a second capacitive element 119 and a third conducting line 1112.

As is specified in the description of the feeding structure according to FIG. 9, resonance is generated at a first resonance frequency by a first closed loop 116. At this point, the first closed loop 116 is formed by the first capacitive element 115 and the second conducting line 113. In addition, the resonance is generated by the capacitance provided by the first capacitive element 115 and the inductance provided by the first closed loop 116.

Resonance is generated at a second resonance frequency by a second closed loop 1111. At this point, the second closed loop 1111 is formed by the first capacitive element 115, the first conducting line 117, the third conducting line 1112, and the second capacitive element 119. In addition, the resonance is generated by the inductance provided by the second closed loop 1111 and the capacitance provided by the first capacitive element 115 and the second capacitive element 119.

At each resonance frequency, current generated by the resonance generates magnetic flux in each closed loop 116 and 1111, and if the magnetic flux generated by each closed loop 116 and 1111 excites the radiator 114, a signal is radiated to outside through the radiator 114 at the resonance frequency of each closed loop 116 and 1111.

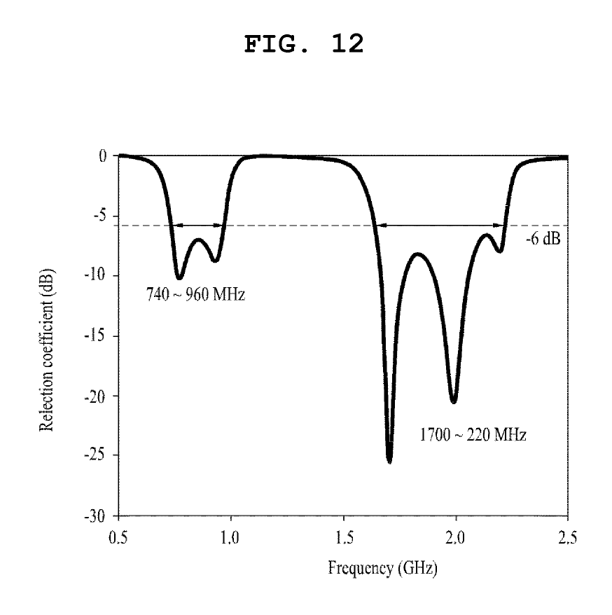

FIG. 12 is a view showing frequency characteristics of an antenna according to the embodiment of FIG. 11. Referring to FIG. 12, it is understood that broadband characteristics are shown in both of two bands. That is, if resonance is generated at a first resonance frequency (a low frequency domain) and a second resonance frequency (a high frequency domain) by the radiator, resonance is generated at a frequency adjacent to the first resonance frequency and the second resonance frequency by adjusting the resonance frequency of the feeding structure, and thus bandwidths of the first band and the second band can be extended.

Resonance is generated around a first bandwidth by adjusting a capacitance value of the first capacitive element 115 and the area of the first closed loop 116, and resonance is generated around a second bandwidth by adjusting a capacitance value of the second capacitive element 119 and the area of the second closed loop 1111.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

The antenna and the feeding method according to the present invention can be used for an antenna of a wireless communication device.

1. An antenna having a broadband feeding structure, the antenna comprising:
a feeding structure, and a radiator having a first resonance frequency and radiating a signal provided by the feeding structure to outside, wherein the feeding structure includes:
a feeding unit for providing the signal; and
a closed loop formed by a capacitive element and a conducting line, wherein
a second resonance frequency generated by the closed loop is a frequency adjacent to the first resonance frequency.

2. The antenna according to claim 1, wherein magnetic flux of the resonance generated in the closed loop is coupled to the radiator and excites the radiator.

3. The antenna according to claim 1, wherein the second resonance frequency is determined by capacitance of the capacitive element and inductance provided by the closed loop.

4. An antenna having a broadband feeding structure, the antenna comprising:
a feeding structure, and a radiator having a first resonance frequency and a second resonance frequency and radiating a signal provided by the feeding structure to outside, wherein the feeding structure includes:
a feeding unit for providing the signal;
a first closed loop formed by a first capacitive element and a conducting line; and
a second closed loop formed by the first capacitive element, a second capacitive element and the conducting line, wherein
a third resonance frequency generated by the first closed loop is formed around the first resonance frequency, and
a fourth resonance frequency generated by the second closed loop is formed around the second resonance frequency.

5. The antenna according to claim 4, wherein the second resonance frequency is a frequency higher than the first resonance frequency.

6. The antenna according to claim 5, wherein capacitance of the first capacitive element has a value higher than that of capacitance of the second capacitive element.

7. The antenna according to claim 4, wherein magnetic flux of resonance generated in the first closed loop or the second closed loop is coupled to the radiator and excites the radiator.

8. The antenna according to claim 4, wherein the third resonance frequency is determined by capacitance of the first capacitive element and inductance provided by the first closed loop.

9. The antenna according to claim 4, wherein the fourth resonance frequency is determined by capacitances of the first capacitive element and the second capacitive element and inductance provided by the second closed loop.

10. An antenna feeding method comprising the steps of:
generating resonance in a closed loop formed by a capacitive element and a conducting line;
exciting a radiator by magnetic flux generated in the closed loop according to the generated resonance;
exciting the radiator by the magnetic flux in a frequency band where the resonance is generated; and
radiating a signal by the excited radiator.

11. The method according to claim 10, wherein a resonance frequency is determined by capacitance of the capacitive element and inductance provided by the closed loop.
